(19) United States
(12) Patent Application Publication
(10) Pub. No.: US 2014/0164887 A1
(43) Pub. Date: Jun. 12, 2014

(54) EMBEDDED CONTENT PRESENTATION

(71) Applicant: MICROSOFT CORPORATION, Redmond, WA (US)

(72) Inventors: Emmanouil Koukoumidis, Bellevue, WA (US); Brian C. Beckman, Newcastle, WA (US); Gur Kimchi, Bellevue, WA (US)

(73) Assignee: Microsoft Corporation, Redmond, WA (US)

(21) Appl. No.: 13/712,505

(22) Filed: Dec. 12, 2012

(51) Int. Cl. G06F 17/22

(52) U.S. Cl. CPC G06F 17/2264
USPC 715/201

(57) ABSTRACT

Among other things, one or more techniques and/or systems are provided for presenting embedded content portraying an entity and/or for maintaining a user profile based upon user exposure to one or more entities. That is, content, such as an image or video, may portray one or more entities (e.g., a product, location, business, etc.). To aid a user in identifying an entity and/or remembering the entity, entity information may be embedded into the content. The entity information may describe the entity and/or provide one or more actions that the user may take with regard to the entity (e.g., open a shopping application to view a hand bag entity). Personalized recommendations may be provided to a user based upon a user profile derived from exposure of the user to various entities (e.g., a vacation recommendation may be provided based upon vacation entities exposed to the user in a positive light).

### BACKGROUND

Many users consume a variety of content through electronic devices, such as televisions, personal computers, mobile devices, tablet devices, etc. In an example, a user may view, upload, organize, and/or share photos through a social network website. In another example, the user may watch a movie through a movie streaming app on a tablet device. In this way, the user may be exposed to a variety of entities comprised within such content. For example, a user may be exposed to a sports car, a new designer hand bag, a coffee shop, a new video game console, and/or a variety of other entities portrayed in the movie (e.g., people, locations, businesses, consumer products, and/or other things). Unfortunately, a user may be unable to identify an entity (e.g., the maker of the new designer hand bag) and/or may not remember the entity after consuming the content (e.g., the user may forget about the coffee shop).

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for presenting embedded content portraying an entity and/or for maintaining a user profile based upon user exposure to one or more entities are provided herein. Content may comprise various types of content, such as a website, social network data, an email, a textual document, a video, an image, audio data, and/or a plethora of other types of content that may be consumed by a user. Content may portray a wide variety of entities, such as people, locations, businesses, consumer products, and/or other types of entities (e.g., a coffee shop, a new video game console, a car, a beach, a house, designer luggage, etc.). Accordingly, as provided herein, entity information, for an entity portrayed within content, may be embedded within the content. The entity information may comprise an entity description (e.g., a textual description, an audio description a, a video description, etc.) that may describe information about the entity (e.g., a model name and a company name associated with designer luggage portrayed within a movie). The entity information may comprise a location or placement of the entity within the content (e.g., a portion of an image depicting the entity, one or more frames of a movie depicting the entity, a time range of a song, etc.). In an example, the entity information may comprise exposure information, such as an emotional bias as to how the entity is portrayed (e.g., an actor may state that the designer luggage is ugly), a duration of the exposure (e.g., the designer luggage may be discussed by the actor for a substantial amount of time, which may leave a relatively strong impression on a user), and/or an intensity rating (e.g., the actor's comments on the designer luggage are a main topic of a long discussion during the movie, as opposed to merely passing-by background comments).

The entity information may be embedded within the content based upon various techniques. In an example, a creator of the content may predefine the entity information (e.g., a movie studio may specify and/or embed metadata within a movie). In another example, an automated technique may utilize audio recognition, image recognition, and/or other recognition techniques to analyze and/or embed entity information within content (e.g., based on automatically identified characteristics of an entity). In another example, a user, that is consuming the content, may identify the entity and/or specify entity information for the entity (e.g., a user may pause a movie, select a portion of a paused frame that depicts the entity, and/or submit entity information, such as an entity description for the entity). In an example, the entity information may be validated based upon a reputation of the user and/or user approval voting for the entity information (e.g., during consumption of the movie by a second user, the second user may have the ability to submit an approval vote, such as a numerical rating or a correct/incorrect vote regarding the identification of the entity and/or information within the entity information, which may (or may not) be aggregated with other (e.g., implicit and/or explicit) approval voting by users). In an example, if ten users specify that an entity is product X and two users specify that the entity is product Y, then the entity may be regarded as product X (e.g., ratio of user input identifying the entity is above a threshold). In another example, a reputation of a user may be used to weight a vote of that user. For example, if a user has a poor reputation (e.g., was one of two users that specified an entity as product Y whereas ten other users specified the entity as product X), a vote of that user may not carry as much weight as a vote from a user with a credible reputation (e.g., was one of the 10 users that specified the entity as product X). Accordingly, a vote from a credible user may trump a vote from a user having a poor reputation. In an example, a user may be assigned a relatively high reputation based upon a number (e.g., a percentage or threshold number) of correct entity submissions, and relatively low reputation based upon a number (e.g., a percentage or threshold number) of incorrect entity submissions. It may be appreciated that entity information may be embedded into the content in various ways (e.g., embedding programming code into the content, embedding HTML into the content, embedding metadata into the content, associating external information, such as a file or a website, with the content, etc.), and that embedding entity information is not merely limited to adding the entity information into the content, but may also comprise associating external entity information with the content.

During consumption of the content, entity information, such as the entity description, may be presented. In an example, the entity information may be displayed contemporaneously with the content. In another example, the entity information may be displayed through an entity summary user interface that may summarize entity information for one or more entities portrayed by the content. In this way, a user may be presented with additional information about the entity (e.g., the user may be presented with the model name and company name for the designer luggage). In an example, the user may be provided an interactive experience based upon task completion logic comprised within the entity information. For example, responsive to receiving user interaction associated with the entity (e.g., the user selects the entity description, the entity, and/or a user interface object, such as a button), a user action option may be invoked (e.g., the user may be navigated to a website associated with the entity, the user may be presented with additional information about the entity, a reminder may be created, an email may be generated, an application may be launched, a purchase option maybe presented, a social network share option may be provided, etc.). In this way, the user may invoke various tasks associated with the entity.

In an example, a user profile may be maintained for the user based upon user exposure to one or more entities portrayed by content consumed by the user (e.g., the user may submit a request for a user profile to be created and/or maintained for the user; the user may select an opt-in option to have a profile maintained on behalf of the user; etc.). For example, the user profile may be populated with a first entry specifying that the user was exposed to an entity during user consumption of first content. The first entry may specify a number of times the user was exposed to an entity and/or an exposure frequency associated with the entity. The first entry may specify exposure times and/or dates when the user was exposed to an entity. The first entry may specify whether the user interacted with entity information, embedded within the first content, for the entity during the user consumption (e.g., the user may have selected an option to view an entity description for the entity). The first entry may specify user inaction associated with an entity exposed to the user during user consumption of content. The first entry may specify exposure information corresponding to an emotional bias as to how the entity is portrayed (e.g., positive, negative, neutral), an exposure size (e.g., whether the entity is depicted in the foreground or background and/or a size of the entity), a duration of the exposure, and/or an intensity rating, among other things. One or more of such entries may be maintained for any number of entities based any one or more of the foregoing and/or any other criteria. A user preference for the entity may be determined based at least in part on the first entry (e.g., and/or other entries associated with the entity and/or the user). A recommendation (e.g., promotional content, an image, a video, a purchase option, social network post data, a reminder, a suggested website, etc.) may be presented to the user based upon the user preference. In this way, personalized recommendations may be provided to users based upon user exposure to entities and/or user preference for such entities.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of presenting embedded content.

FIG. 2 is a component block diagram illustrating an exemplary system for presenting embedded content.

FIG. 3 is an illustration of an example of performing a user action based upon user interaction associated with an entity portrayed by image content.

FIG. 4 is an illustration of an example of performing a user action based upon user interaction associated with an entity portrayed by image content.

FIG. 5 is an illustration of an example of user identification of an entity within video content.

FIG. 6 is a flow diagram illustrating an exemplary method of maintaining a user profile.

FIG. 7 is a component block diagram illustrating an exemplary system for maintaining a user profile.

FIG. 8 is an illustration of an exemplary computing device-readable medium wherein processor-executable instructions configured to embody one or more of the provisions set forth herein may be comprised.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

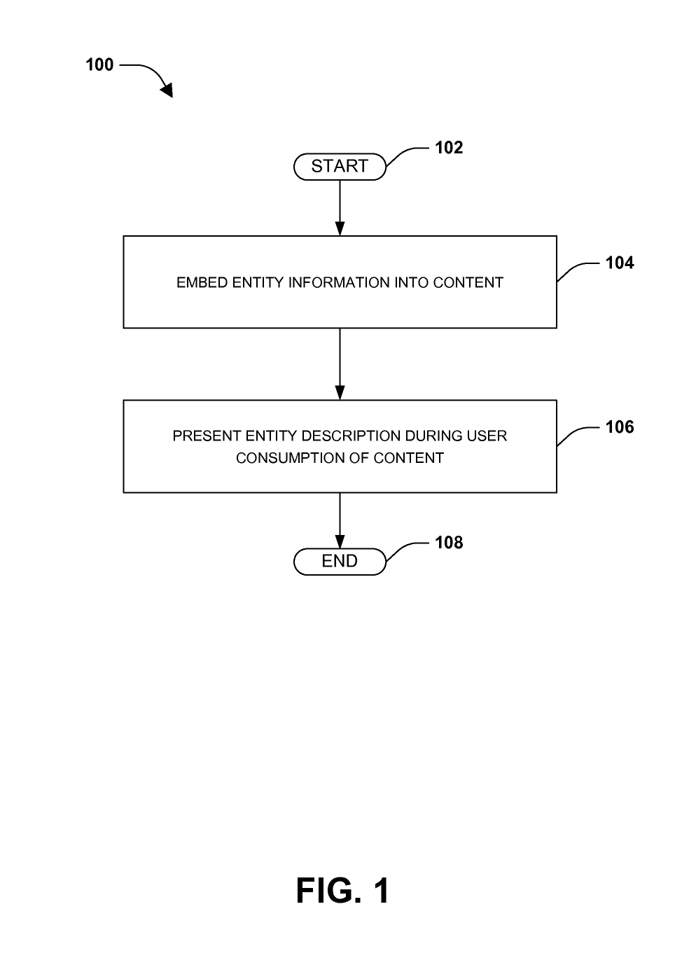

One embodiment of presenting embedded content is illustrated by an exemplary method 100 in FIG. 1. At 102, the method starts. A user may consume content that may portray one or more entities, such as a consumer product, a location, a business, etc., through the content. In an example, a textual name of an entity may occur within a text document, a social network post, a web page, and/or an email. In another example, a visual depiction of the entity may occur within a video and/or an image. In another example, an audio depiction of the entity may occur within audio data (e.g., an occurrence of the audio depiction).

Because a user may not recognize specific details about an entity and/or may forget about the entity after consuming the content, entity information may be embedded into content, at 104. It may be appreciated that entity information may be embedded into the content in various ways (e.g., embedding programming code into the content; embedding HTML into the content, embedding metadata into the content, associating external information, such as a file or website, with the content, etc.), and that embedding entity information is not merely limited to adding the entity information into the content, but may also comprise associating external entity information with the content. The entity information may comprise an entity description of the entity (e.g., a textual description, an audio description, and/or a video description that may describe various details about the entity, such as a name, model, location, price, etc.). The entity information may comprise a location or positioning of the entity within the content (e.g., a time span of a movie or audio data, a portion of an image, character positions within an article, a user interface object identifier within a web page, a set of frames of a movie, etc.). It may be appreciated that the entity information may comprise a variety of information relating to the entity and/or how the entity is portrayed by the content. In an example, the entity information may comprise exposure information. The exposure information may correspond to an emotional bias as to how the entity is portrayed (e.g., positive, negative, neutral, etc.), a duration of an exposure of the entity (e.g., a percentage of pixels of an image, a number of frames of a movie, a number of paragraphs comprising the entity, etc.), and/or an intensity rating of the emotional bias (e.g., a relatively low intensity rating may be specified for a background appearance of a car within a crowded traffic scene), among other things.

Various techniques may be used to embed the entity information into the content. In an example, the entity information may be embedded offline (e.g., by a creator of the content before user consumption of the content). In another example, an automated technique may be used to identify the entity and/or embed the entity information within the content. For example, an image recognition technique (e.g., configured to access an image repository and/or perform an image search through a search engine) and/or an audio recognition technique may be used to identify the entity (e.g., responsive to the audio recognition technique determining that an actor mentioned a consumer product name, the image recognition techniques may be used to locate the consumer product within the content). In another example, a user may identify the entity and/or specify entity information for the entity (e.g., during consumption of the content). For example, responsive to receiving user input that identifies the entity within the content, entity information may be determined and/or embedded into the content. Because the user may incorrectly identify the entity, the entity information (e.g., an entity description, such as a name of the consumer product, provided by the user) maybe validated based upon a reputation of the user (e.g., a determination as to whether the reputation is above a reputation threshold) and/or based upon user approval vote (e.g., a determination that the user approval vote (e.g., from other users) is above an approval threshold).

During consumption of the content, the entity description and/or other entity information may be presented in a variety of ways. In an example, the entity description may be overlaid on the content. In another example, the entity description may be displayed within the content. In another example, the entity description may be displayed outside of the content (e.g., a separate user interface and/or user interface object). In another example, the entity description may be displayed through an entity summary page for the content (e.g., a summary describing various entities that are portrayed by the content). In another example, during consumption of the content, no entity information may be displayed until a user selects a portion of the consumed content (e.g., the user clicks on an actor's handbag). In another example, a user action option may be presented based upon task completion logic comprised within the entity information. The user action option may correspond to a variety of actions, such as navigating to a website or URL, creating a reminder about the entity, obtaining additional information about the entity, initiating a purchase option for the entity, sharing information about the entity through a social network, executing an application (e.g., a shopping app for a consumer product entity, a vacation app for a location entity, etc.), sending an email about the entity to one or more users, etc. In this way, the user may have an interactive experience with the entity and/or the entity information. It is to be appreciated that the ways that the entity description and/or other entity information may be presented are not limited to the foregoing examples, and that the instant application, including the scope of the appended claims, is not intended to be limited to the same. At 108, the method ends.

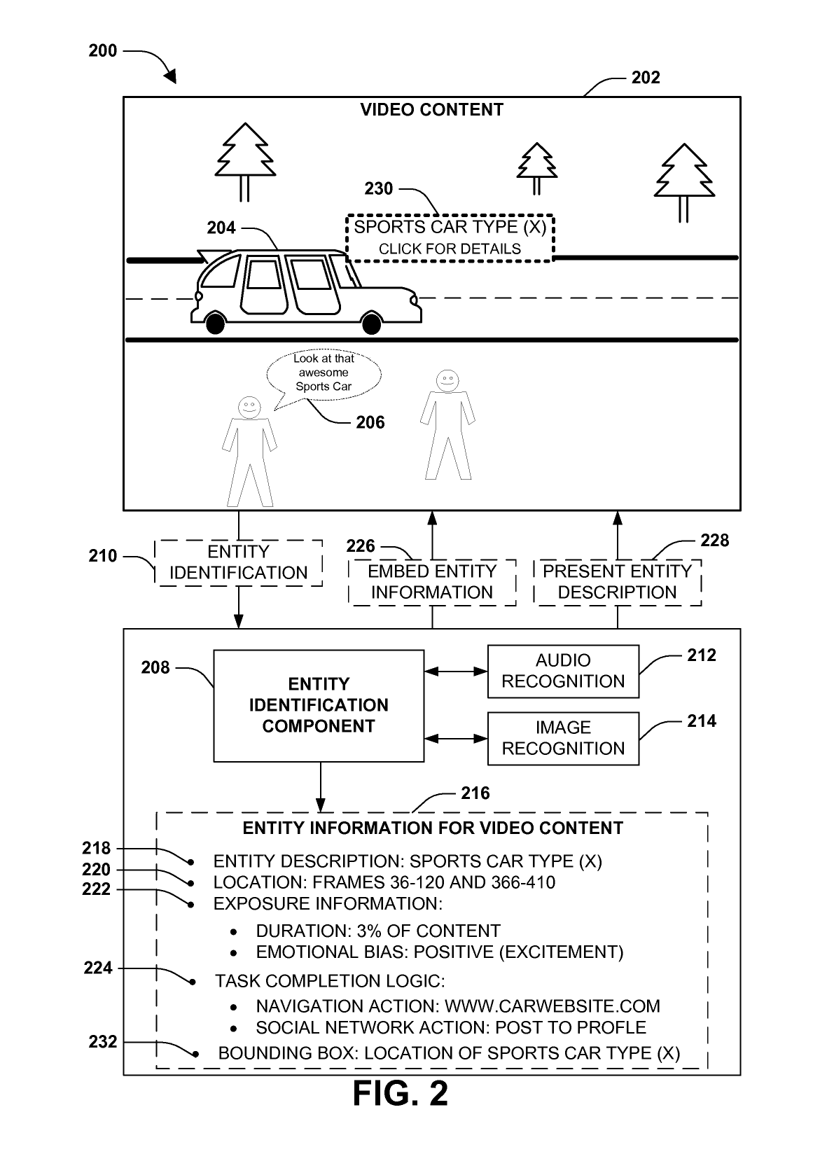

FIG. 2 illustrates an example of a system 200 configured for presenting embedded content. The system 200 may comprise an entity identification component 208. The entity identification component 208 may be associated with video content 202 (e.g., a movie depicting, among other things, two individuals discussing a sports car that drove past them). The entity identification component 208 may be configured to embed 226 entity information (e.g., entity information 216 associated with a sports car entity 204 depicted within the content video 202) into the video content 202. In an example, the entity identification component 208 may be configured to identify 210 an entity, such as the sports car entity 204, within the video content 202. For example, the entity identification component 208 may utilize an audio recognition technique 212 to determine that a statement 206 made by an actor is indicative of the sports car entity 204. Based upon the statement 206, the entity identification component 208 may utilize an image recognition technique 214 to recognize a visual depiction of the sports car entity 204. In this way, the entity identification component 208 may identify 210 the sports car entity 204. It may be appreciated that other techniques may be used to identify the sports car entity (e.g., the video content may be associated with metadata identifying the sports car entity 204, a user may have identified the sports car entity 204, etc.).

In an example, the entity information 216 may comprise an entity description 218 that describes the sports car entity 204 as a sports car type (X). The entity information 216 may comprise a location 220 of the sports car entity 204 within the video content 202 (e.g., the sports car entity 204 may be depicted from frames 36 to 120 and from frames 366 to 410). The entity information 216 may comprise exposure information 222, such as a duration of an exposure of the sports car entity 204 (e.g., the sports car entity 204 may be portrayed within the video content for 3% of the video) and/or emotional bias as to how the sports car entity 204 is portrayed (e.g., the statement 206 may indicate that the actor is excited about the sports car entity 204). The entity information 216 may comprise task completion logic 224 (e.g., a navigation action to a website and/or a social network post action). In this way, the entity identification component 208 may embed 226 the entity information 216 or a portion thereof into the video content 202. In an example, the entity identification component 208 may embed 226 a bounding box 232 (e.g., a polygon) specifying a location (e.g., pixel coordinates) of the entity within one or more frames. Thus, when a user selects the location of the entity (e.g., corresponding pixel(s)), the entity description, task completion logic, and/or other information may be displayed.

The entity identification component 208 may be configured to present 228 at least a portion of the entity information 216, such as the entity description 218, during consumption of the video content 202. For example, the entity identification component 208 may display a notification object 230 comprising the entity description 218. User interaction (e.g., a gesture, such as swipe, mouse-click, etc.) with the notification object 230 may be supported, such that one or more user actions (e.g., the navigation action and/or the social network post action) may be invoked based upon user interaction with the notification object 230. It may be appreciated that the entity description 218 may be presented through a variety of techniques (e.g., a menu, an overlay object, a separate user interface, etc.). In this way, a user consuming the video content 202 may obtain information regarding the sports car entity 204 and/or may perform various user actions associated with the sports car entity 204.

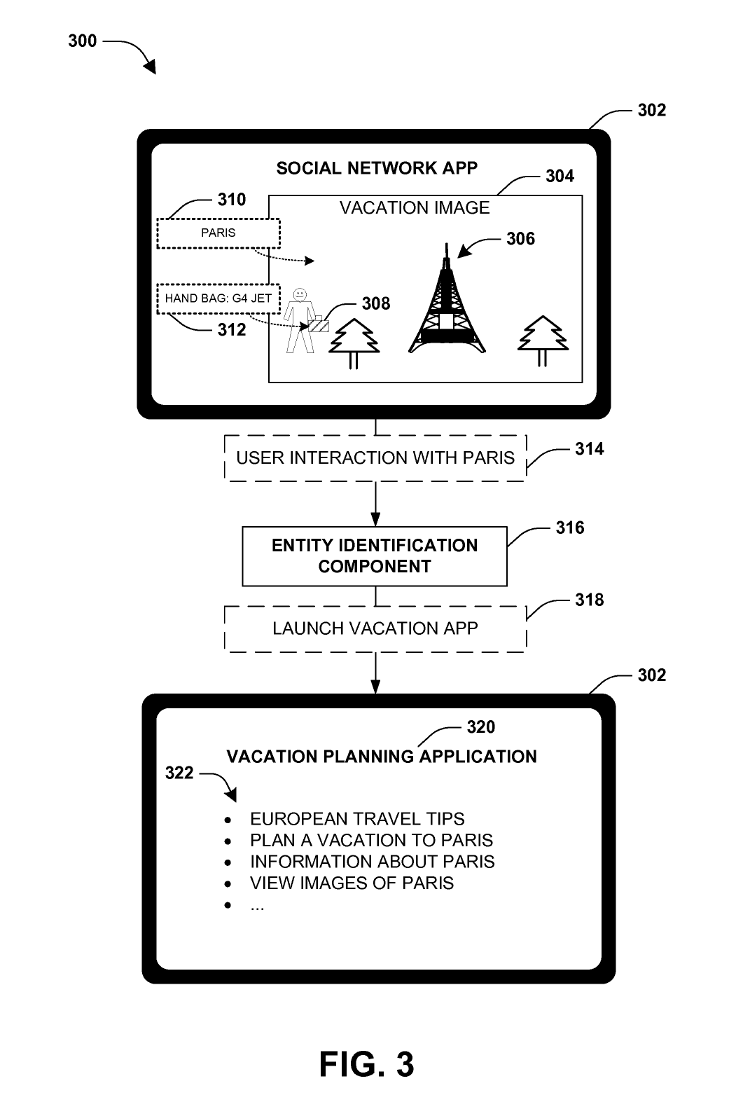

FIG. 3 illustrates an example 300 of performing a user action based upon user interaction associated with an entity portrayed by image content. An electronic device 302, such as a tablet device, may host a social network app. A user may consume vacation image content 304 through the social network app (e.g., the user may view a photo shared by a second user). The vacation image content 304 may portray one or more entities, such a Paris entity 306 and/or a designer hand bag entity 308. Entity information, such as a Paris entity description 310 and/or a designer hand bag description 312, may have been embedded within the vacation image content 304. During consumption of the vacation image content 304, the Paris entity description 310 and/or the designer hand bag description 312 may be presented, which may provide the user with additional details regarding the Paris entity 306 and/or the designer hand bag entity 308.

An entity identification component 316 may be configured to detect user interaction with an entity. For example, the entity identification component 316 may detect 314 a user selection of the Paris entity description 310 associated with the Paris entity 306. Responsive to the user selection, the entity identification component 316 may perform a user action associated with the Paris entity 306 (e.g., based upon task completion logic associated with embedded entity information for the vacation image content 304). For example, the entity identification component 316 may launch 318 a vacation planning app 320 based upon an application launch user option specified by task completion logic. In this way, the user may be presented with various information and/or user actions that may be performed (e.g., information 322).

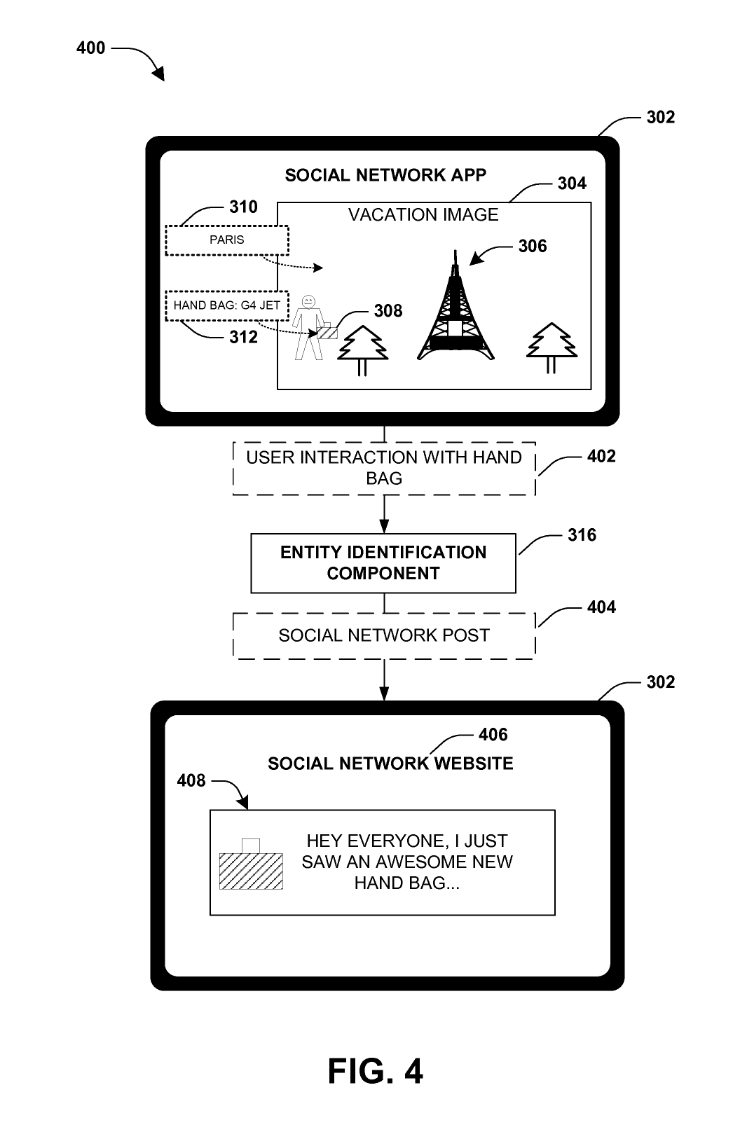

FIG. 4 illustrates an example 400 of performing a user action based upon user interaction associated with an entity portrayed by image content. It may be appreciated that in an example, vacation image content 304 may correspond to vacation image content 304 of FIG. 3. For example, an electronic device 302 may host a social network app. A user may consume the vacation image content 304 through the social network app. The vacation image content 304 may portray one or more entities, such a Paris entity 306 and/or a designer hand bag entity 308. Entity information, such as a Paris entity description 310 and/or a designer hand bag description 312, may have been embedded within the vacation image content 304. During consumption of the vacation image content 304, the Paris entity description 310 and/or the designer hand bag description 312 may be presented, which may provide the user with additional details regarding the Paris entity 306 and/or the designer hand bag entity 308.

An entity identification component 316 may be configured to detect user interaction with an entity. For example, the entity identification component 316 may detect 402 a user selection of the designer hand bag description 312 associated with the designer hand bag entity 308. Responsive to the user selection, the entity identification component 316 may perform a user action associated with the hand bag entity 308 (e.g., based upon task completion logic associated with embedded entity information for the vacation image content 304). For example, the entity identification component 316 may generate 404, within a social network website 406, a social network post 408 regarding the designer hand bad entity 308.

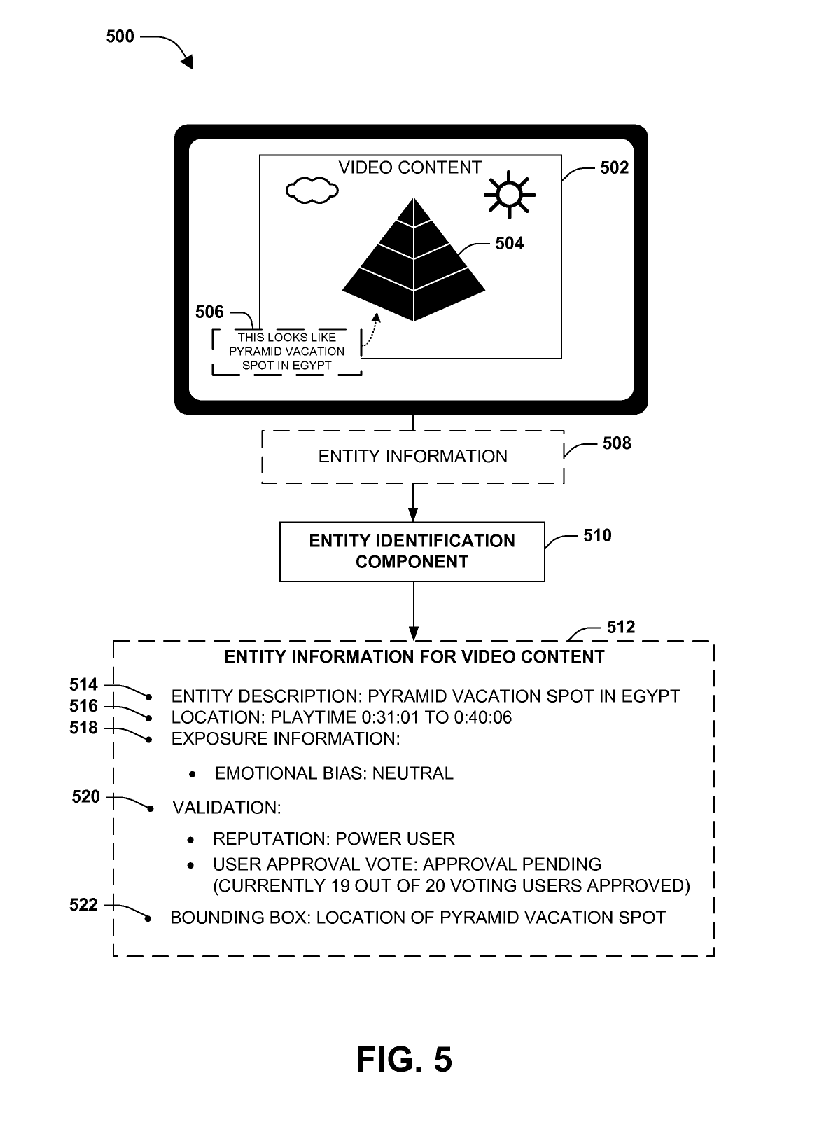

FIG. 5 illustrates an example 500 of user identification of an entity within video content 502. In an example, the video content 502 may comprise one or more entities, such as people, locations, consumer products, and/or businesses that are not yet identified within the video content 502. During consumption of the video content 502, a user may identify 506 a pyramid vacation entity 504 within the video content 502 (e.g., the user may select the pyramid vacation entity 504 while watching the movie, which may allow the user to input entity information 508). An entity identification component 510 may be configured to detect the entity information 508 associated with the user identifying 506 the pyramid vacation entity 504. The entity identification component 510 may maintain entity information for one or more entities portrayed by the video content 502. In an example, the entity identification component 510 may create entity information 512 for the pyramid vacation entity 504. The entity identification component 510 may specify an entity description 514 for the pyramid vacation entity 504, a location 516 of the pyramid vacation entity 504 within the video content 502, a bounding box 522 specifying a location (e.g., pixel coordinates) of the pyramid vacation entity 504, and/or exposure information 518, such as emotional bias for the pyramid vacation entity 504. Because the pyramid vacation entity 504 may be misidentified, the entity identification component 510 may comprise validation information 520 used to validate the entity information 508 (e.g., one or more other users (e.g., having respective reputations, levels of trustworthiness, etc.) may vote on whether they agree with the user's identification of the entity). In this way, the user may identify an entity within content so that entity information for the entity may be embedded into the content.

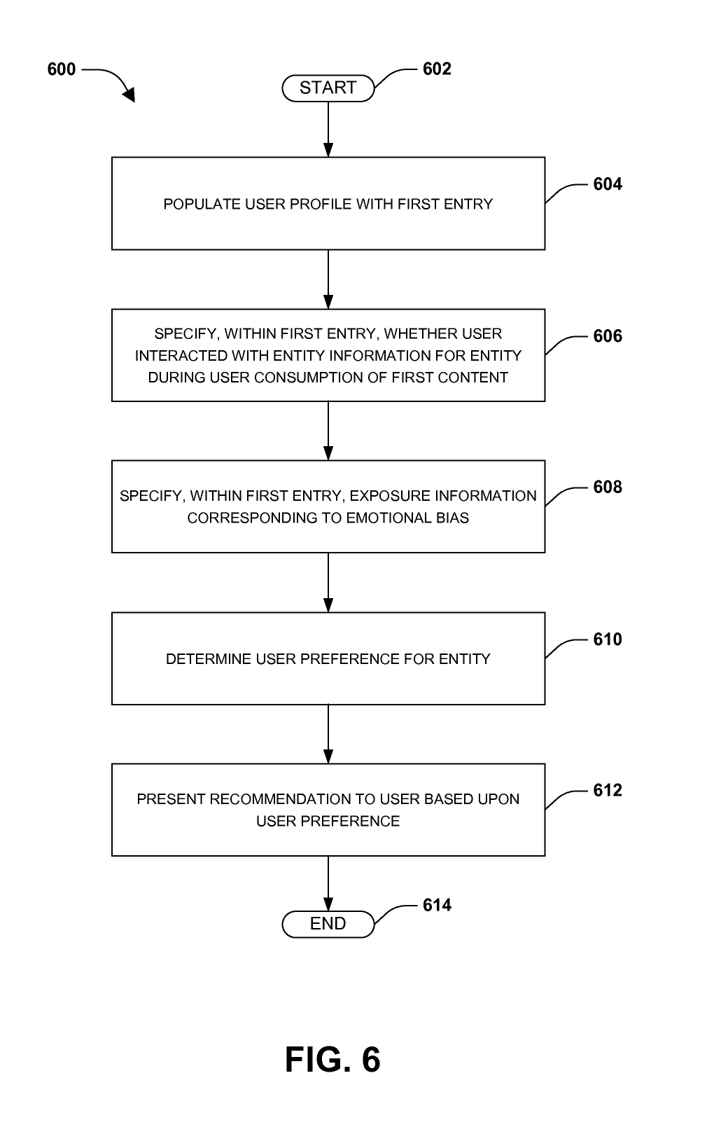

One embodiment of maintaining a user profile is illustrated by an exemplary method 600 in FIG. 6. At 602, the method starts. At 604, a user profile may be populated with a first entry specifying that a user was exposed to an entity during user consumption of first content. For example, a user may view a designer hand bag while watching a movie. Entity information, embedded into the movie, for the designer hand bag may have been presented to the user. In an example, a description of the designer hand bag may be presented to the user. In another example, a user action that the user may take upon the entity, such as opening a shopping app to view the designer hand bag may be provided to the user. At 606, information may be specified within the first entry as to whether the user interacted with the entity information (e.g., the user may have selected the entity information and/or invoked the user action) for the entity during the user consumption of the first content. At 608, exposure information may be specified within the first entry. The exposure information may correspond to an emotional bias as to how the entity was portrayed by the first content (e.g., was the designer hand bag presented in a positive or negative light). At 610, a user preference for the entity may be determined based at least in part on the first entry. It may be appreciated that in an example, one or more entries (e.g., corresponding to the entity and/or other entities exposed to the user) may be populated within the user profile. In this way, a recommendation may be presented to the user based upon the user preference, at 612. For example, a personalized recommendation for designer luggage may be provided to the user (e.g., through an email or other notification mechanism) based upon the user preference indicating that the user was exposed to various designer items in a positive light and/or that the user expressed interest in such items. It is to be appreciated that a user may opt in, for example, to having a user profile developed and/or maintained as described herein.

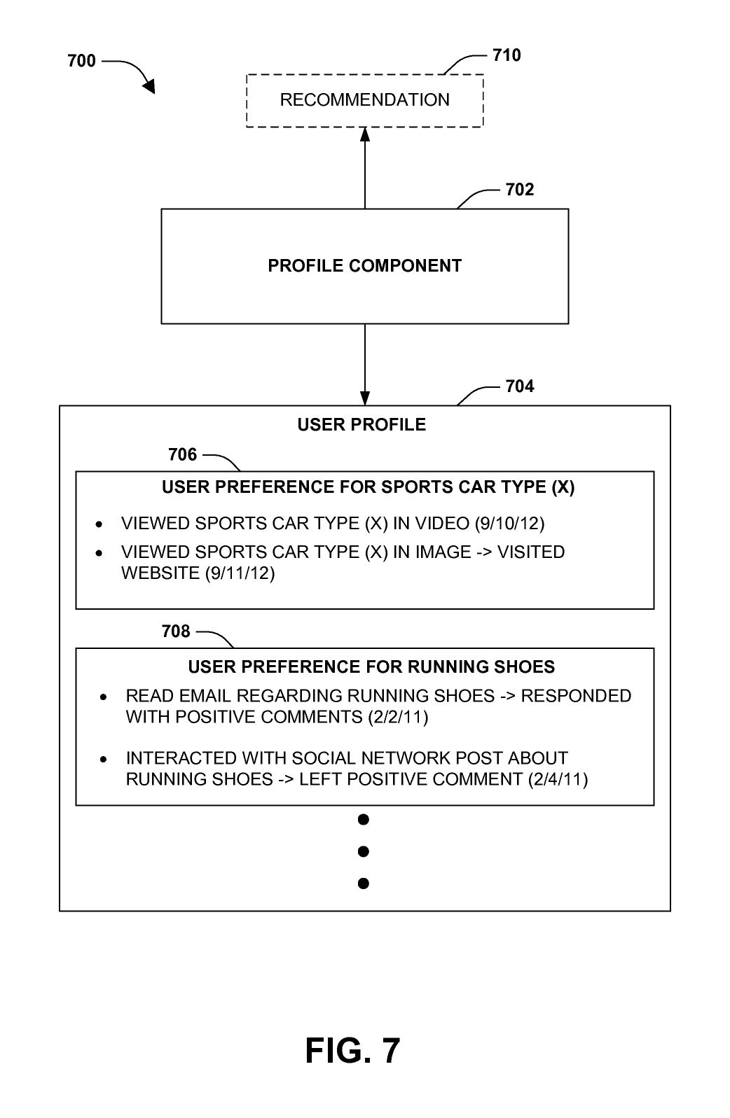

FIG. 7 illustrates an example of a system 700 configured for maintaining a user profile 704. The system 700 may comprise a profile component 702. The profile component 702 may be configured to maintain the user profile 704 associated with a user that may have been exposed to one or more entities (e.g., a car, running shoes, a coffee shop, a national park, etc.) while consuming content, such as a video, an article, a website, an image, etc. In an example, the profile component 702 may populate the user profile 704 with a first entry 706. The first entry 706 may correspond to a user preference for a sports car type (X) entity. The first entry 706 may be based upon one or more user exposures to the sports car type (X) entity. In an example, the user may have viewed the sports car type (X) entity through a video. In another example, the user may have viewed the sports car type (X) entity through an image, and may have performed a user action to visit a website regarding the sports car type (X) entity (e.g., the user action may have been invoked based upon entity information embedded in the image). The profile component 702 may populate the user profile 704 with one or more entries, such as a second entry 708 corresponding to a user preference for running shoes. In an example, the profile component 702 may specify an exposure date within an entry of the user profile, which may be indicative of an impression rating of user exposure to an entity associated with the entry (e.g., a recently viewed entity may have a relatively high impression rating, such as entries relating to the sports car type (X) entity in 2012 as compared to less recently viewed entries relating to the running shoes entity in 2011). In this way, the profile component 702 may provide a recommendation 710 based upon the user preference associated with the first entry 706, the second entry 708, and/or other entries not illustrated. It is to be appreciated that a user may opt in, for example, to having a user profile developed and/or maintained as described herein.

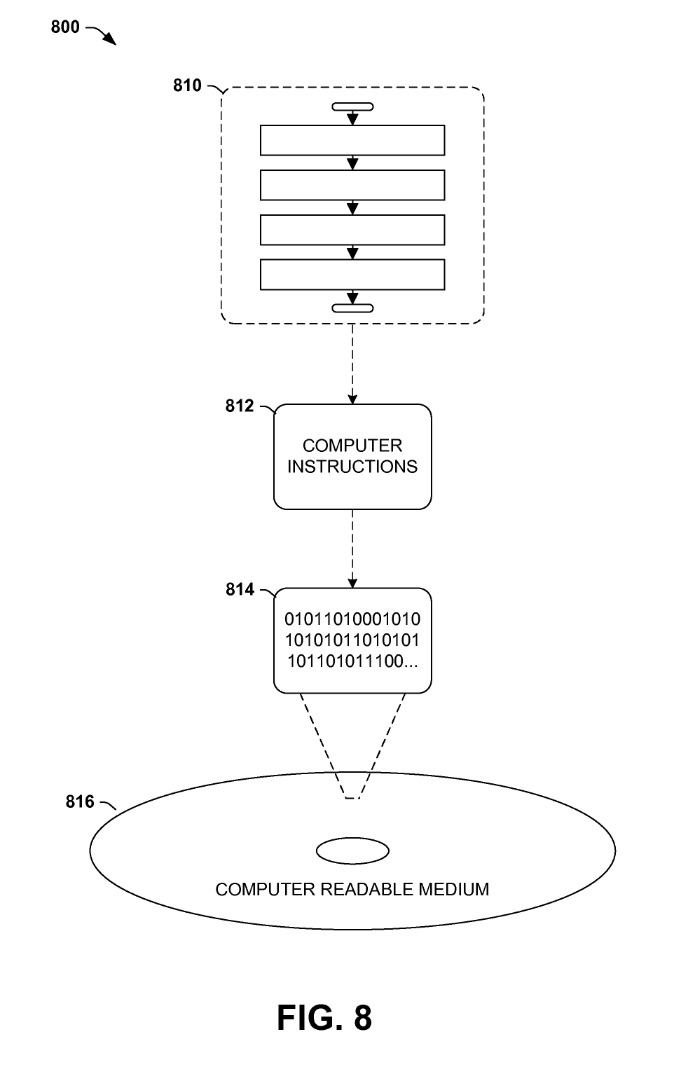

Still another embodiment involves a computing device-readable medium comprising processor-executable instructions, such as a computer program product, configured to implement one or more of the techniques presented herein. An exemplary computing device-readable medium, such as computer readable storage, that may be devised in these ways is illustrated in FIG. 8, wherein the implementation 800 comprises a computing device-readable medium 816 (e.g., a CD-R, DVD-R, or a platter of a hard disk drive), on which is encoded computing device-readable data 814. This computing device-readable data 814 in turn comprises a set of computing device instructions 812 configured to operate according to one or more of the principles set forth herein. In one such embodiment 800, the processor-executable computing device instructions 812 may be configured to perform a method 810, such as at least some of the exemplary method 100 of FIG. 1 and/or at least some of exemplary method 600 of FIG. 6, for example. In another such embodiment, the processor-executable instructions 812 may be configured to implement a system, such as at least some of the exemplary system 200 of FIG. 2 and/or at least some of the exemplary system 700 of FIG. 7, for example. Many such computing device-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computing device-related entity, either hardware, a combination of hardware and software, software, or software in execution. For example, a component may be, but is not limited to being, a process running on a processor, a processor, an object, an executable, a thread of execution, a program, and/or a computing device. By way of illustration, both an application running on a controller and the controller can be a component. One or more components may reside within a process and/or thread of execution and a component may be localized on one computing device and/or distributed between two or more computing devices.

Furthermore, the claimed subject matter may be implemented as a method, apparatus, or article of manufacture using standard programming and/or engineering techniques to produce software, firmware, hardware, or any combination thereof to control a computing device to implement the disclosed subject matter. The term “article of manufacture” as used herein is intended to encompass a computing device program accessible from any computing device-readable device, carrier, or media. Of course, those skilled in the art will recognize many modifications may be made to this configuration without departing from the scope or spirit of the claimed subject matter.

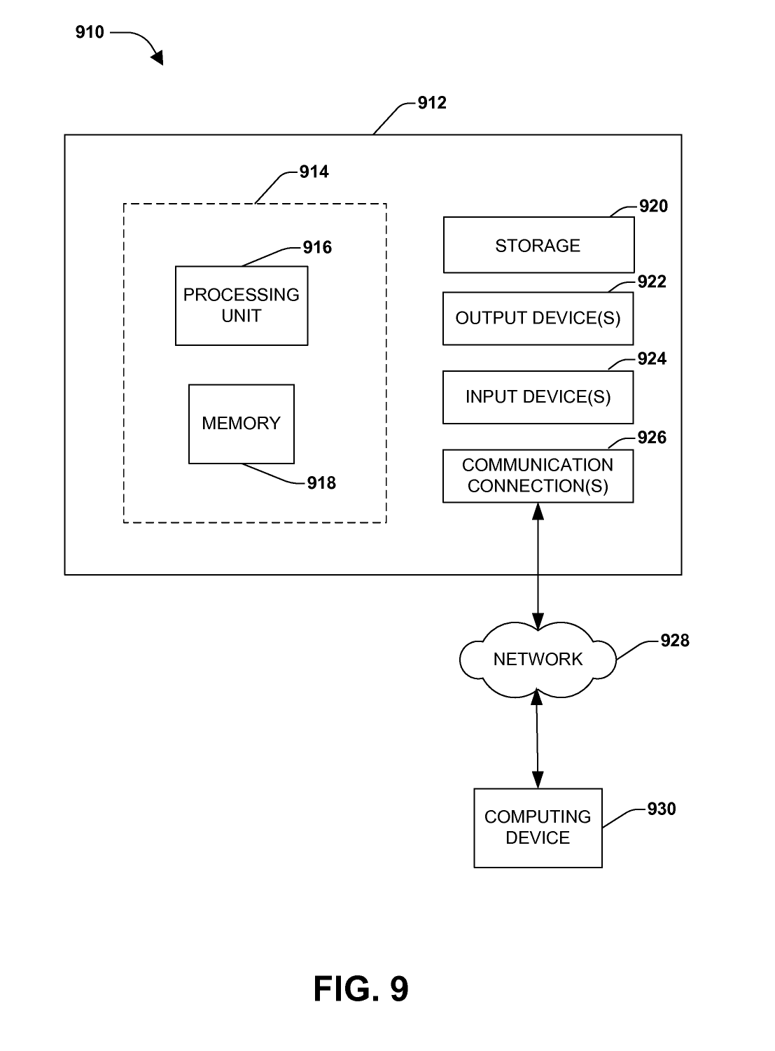

FIG. 9 and the following discussion provide a brief, general description of a suitable computing environment to implement embodiments of one or more of the provisions set forth herein. The operating environment of FIG. 9 is only an example of a suitable operating environment and is not intended to suggest any limitation as to the scope of use or functionality of the operating environment. Example computing devices include, but are not limited to, personal computing devices, server computing devices, hand-held or laptop devices, mobile devices (such as mobile phones, Personal Digital Assistants (PDAs), media players, and the like), multiprocessor systems, consumer electronics, mini computing devices, mainframe computing devices, distributed computing environments that include any of the above systems or devices, and the like.

Although not required, embodiments are described in the general context of “computing device readable instructions” being executed by one or more computing devices. Computing device readable instructions may be distributed via computing device readable media (discussed below). Computing device readable instructions may be implemented as program modules, such as functions, objects, Application Programming Interfaces (APIs), data structures, and the like, that perform particular tasks or implement particular abstract data types. Typically, the functionality of the computing device readable instructions may be combined or distributed as desired in various environments.

FIG. 9 illustrates an example of a system 910 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computing device readable instructions to implement one or more embodiments provided herein may be in storage 920. Storage 920 may also store other computing device readable instructions to implement an operating system, an application program, and the like. Computing device readable instructions may be loaded in memory 918 for execution by processing unit 916, for example.

The term “computing device readable media” as used herein includes computing device storage media. Computing device storage media includes volatile and nonvolatile, removable and non-removable media implemented in any method or technology for storage of information such as computing device readable instructions or other data. Memory 918 and storage 920 are examples of computing device storage media. Computing device storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computing device storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computing device readable media” may include communication media. Communication media typically embodies computing device readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computing device readable instructions may be distributed across a network. For example, a computing device 930 accessible via a network 928 may store computing device readable instructions to implement one or more embodiments provided herein. Computing device 912 may access computing device 930 and download a part or all of the computing device readable instructions for execution. Alternatively, computing device 912 may download pieces of the computing device readable instructions, as needed, or some instructions may be executed at computing device 912 and some at computing device 930.

Various operations of embodiments are provided herein. In one embodiment, one or more of the operations described may constitute computing device readable instructions stored on one or more computing device readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A method for presenting embedded content, comprising:
embedding entity information into content, the entity information comprising an entity description of an entity portrayed within the content and a location of the entity within the content; and
presenting the entity description during user consumption of the content.

2. The method of claim 1, the entity information comprising exposure information corresponding to at least one of:
an emotional bias as to how the entity is portrayed;
an exposure size; or
a duration of an exposure of the entity.

3. The method of claim 1, the entity corresponding to at least one of:
a textual name of the entity occurring within at least one of a textual document, a social network post, a web page, or an email;
a visual depiction of the entity occurring within at least one of a video or an image; or
an audio depiction of the entity occurring within audio data.

3. (canceled)

4. The method of claim 1, the entity information comprising task completion logic.

5. The method of claim 4, the presenting comprising:
providing a user action option based upon the task completion logic, the user action option corresponding to at least one of: a navigation action to a URL associated with the entity, a create reminder action regarding the entity, an obtain additional information action about the entity, a purchase option for the entity, or a social network option to share information about the entity.

6. The method of claim 4, comprising:
responsive to receiving user interaction associated with the entity, providing the user with additional information about the entity based upon the task completion logic.

7. The method of claim 4, comprising:
responsive to receiving user interaction associated with the entity, executing an application based upon the task completion logic.

8. The method of claim 4, comprising:
responsive to receiving user interaction associated with the entity, navigating a user to a website based upon the task completion logic.

9. The method of claim 1, the embedding entity information into content comprising at least one of:
embedding the entity information offline; or
responsive to receiving user input that identifies the entity within the content during consumption of the content, embedding the entity information into the content.

10. The method of claim 1, comprising:
validating the entity information based upon at least one of:
determining that a ratio of user input identifying the entity is above a threshold;
determining that a reputation of a user associated with the entity information is above a reputation threshold; or
determining that a user approval vote for the entity information is above an approval threshold.

11. The method of claim 1, the embedding entity information into content comprising:
identifying the entity within the content utilizing at least one of an image recognition technique or an audio recognition technique.

12. The method of claim 11, the identifying comprising:
responsive to identifying an audio depiction of the entity utilizing the audio recognition technique, executing the image recognition technique upon at least a portion of the content associated with an occurrence of the audio depiction.

13. The method of claim 11, comprising:
identifying the entity utilizing the image recognition technique based upon at least one of an image search of an image repository or an image search through a search engine.

14. The method of claim 1, comprising:
maintaining a user profile associated with a user that consumed the content; and
populating the user profile with an entry specifying that the user was exposed to the entity.

15. The method of claim 14, the maintaining a user profile comprising:
maintaining at least one of exposure frequencies or exposure dates associated with one or more entities to which the user was exposed.

16. The method of claim 15, comprising:
determining a user preference for the entity based upon an exposure frequency associated with the entity; and
presenting a recommendation to the user based upon the user preference.

17. The method of claim 16, the user preference based upon at least one of:
emotional bias information associated with exposure of the entity; or
user interaction or user inaction associated with the user consumption.

18. A method for maintaining a user profile, comprising:
populating the user profile with a first entry specifying that a user was exposed to an entity during user consumption of first content;
specifying, within the first entry, whether the user interacted with entity information for the entity during the user consumption of the first content, the entity information embedded within the first content;
specifying, within the first entry, exposure information corresponding to an emotional bias as to how the entity was portrayed by the first content;
determining a user preference for the entity based at least in part on the first entry; and
presenting a recommendation to the user based upon the user preference.

19. The method of claim 18, comprising:
populating the user profile with a second entry specifying that the user was exposed to the entity during user consumption of second content; and
updating the user preference based upon the second entry.

20. A system for presenting embedded content, comprising:
an entity identification component configured to:
embed entity information into content, the entity information comprising at least one of an entity description of an entity portrayed within the content, task completion logic, or exposure information corresponding to at least one of an emotional bias as to how the entity was portrayed by the content or an entity location within the content; and
present at least some of the entity information during user consumption of the content by a user; and
a profile component configured to:
maintain a user profile, utilized for personalized recommendations, for a user that was exposed to one or more entities during consumption of the content.
